(19) United States
(12) Patent Application Publication
(10) Pub. No.: US 2007/0131207 A1
(43) Pub. Date: Jun. 14, 2007

(54) Exhaust gas recirculation in diesel engine

(75) Inventor: Akihide Nakamura, Chigasaki-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/637,046

(22) Filed: Dec. 12, 2006

(30) Foreign Application Priority Data
Dec. 13, 2005 (JP) 2005-358998

(51) Int. Cl. F02M 25/07; F02B 47/08

(52) U.S. Cl. 123/568.12; 123/41.31

(57) ABSTRACT

A diesel engine (1) cools recirculated exhaust gas in an EGR passage (4) having an EGR valve (6) through heat exchange with a coolant in an EGR cooler (7). The flow of the coolant through a coolant passage (11-13) which circulates the coolant to the EGR cooler (7) is adjusted by a flow control valve (14). A controller (31) calculates the inlet temperature of the EGR valve (6) and the concentration of a soluble organic fraction contained in the recirculated exhaust gas, and determines whether or not a deposit of the recirculated exhaust gas accumulates in the EGR valve (6) on the basis of these values. When the determination is affirmative, the controller (31) controls the flow control valve (14) to reduce the coolant flow, thereby preventing a deposit of a component of the recirculated exhaust gas from being formed in the EGR valve (6) and EGR cooler (7).

### FIELD OF THE INVENTION

This invention relates to the cooling of recirculated exhaust gas in a diesel engine.

### BACKGROUND OF THE INVENTION

In an exhaust gas recirculation (EGR) system which recirculates a part of the exhaust gas from a diesel engine to an intake passage as recirculated exhaust gas, if the temperature of the recirculated exhaust gas rises excessively, the proportion of recirculated exhaust gas in the intake air of the engine becomes excessive, leading to a reduction in the amount of fresh air entering the cylinder of the engine. As a result, the combustion speed and combustion temperature of the air-fuel mixture cannot be reduced sufficiently. Conversely, if the temperature of the recirculated exhaust gas is too low, the intake air temperature and the atmospheric temperature in a combustion chamber cannot be raised using the heat of the recirculated exhaust gas when the engine is cold or the like, and as a result, complete combustion of the air-fuel mixture becomes difficult.

Therefore, during exhaust gas recirculation, the temperature of the recirculated exhaust gas must be maintained at an appropriate temperature. JP2004-183549A, published by the Japan Patent Office in 2004, proposes providing an EGR cooler for cooling recirculated exhaust gas by performing heat exchange between the recirculated exhaust gas and a circulating coolant, and maintaining the temperature of the recirculated exhaust gas within an appropriate range by adjusting the flow of the coolant using a control valve.

### SUMMARY OF THE INVENTION

Recirculated exhaust gas is a part of the exhaust gas of a diesel engine, and therefore the recirculated exhaust gas contains particulate matter. The particulate matter may be divided into a soluble organic fraction (SOF) that melts in an organic solvent, and an insoluble organic fraction (ISF). The SOF component is constituted by hydrocarbon (HC) and lubricating oil, while the ISF component is constituted by solid carbon or soot and sulfur oxide.

When recirculated exhaust gas containing these components is cooled by the EGR cooler, the components may accumulate in the EGR cooler, leading to an increase in the recirculated exhaust gas flow resistance of the recirculated exhaust gas passage. Alternatively, the components may accumulate in the interior of an EGR valve, adversely affecting operations of the EGR valve.

In the prior art, it is believed that these deposits are caused when unburned fuel in the recirculated exhaust gas, having soot or hydrocarbon (HC) as its main component, sticks to the wall surface of the EGR passage. Accordingly, the prior art proposes that when the air-fuel ratio of an air-fuel mixture to be burned in the diesel engine is lean, the recirculated exhaust gas be cooled by opening a control valve such that coolant is caused to circulate to the EGR cooler, and when the air-fuel ratio is rich, the control valve be closed such that the recirculated exhaust gas is not cooled by the coolant. The reason for this is that when the air-fuel ratio of the air-fuel mixture is lean, almost no soot and hydrocarbon is discharged, but when the air-fuel ratio of the air-fuel mixture is rich, large amounts of soot and hydrocarbon are discharged. The prior art aims to suppress deposit accumulation by halting the supply of coolant to the EGR cooler when the air-fuel ratio is rich such that the temperature of the recirculated exhaust gas rises.

The inventors investigated the relationship between an SOF concentration Xsof, or in other words the SOF discharge amount per predetermined time, and an EGR valve inlet temperature Tinegr, or in other words the temperature of the recirculated exhaust gas at the inlet to the EGR valve, under various diesel engine running conditions, and the results shown in FIG. 3 were obtained. The ordinate of the figure shows the EGR valve inlet temperature Tinegr, while the abscissa shows the SOF concentration Xsof.

The three white squares in the figure show results obtained when the recirculated exhaust gas is not cooled by the EGR cooler. The white triangles and rhomboids in the figure show results obtained when no deposit exists in the EGR valve and EGR cooler. The black triangles and circles in the figure show results obtained when a deposit exists in the EGR valve and EGR cooler.

From these results, the inventors came to believe that the curve shown by the broken line in the figure is a boundary separating a zone in which a deposit is formed in the EGR valve and EGR cooler from a zone in which no deposit is formed. More specifically, the upper side of the curve is a non-deposit zone, and in this region, a deposit is unlikely to form in the EGR valve and EGR cooler. On the other hand, the lower side of the curve is a deposit zone, and in this region, a deposit is formed easily in the EGR valve and EGR cooler.

Although only four sets of data were obtained in relation to cases in which a deposit accumulates in the EGR valve and EGR cooler, the significance of this small number of cases cannot be ignored. The reason for using the concentration of the soluble organic fraction SOF on the abscissa is that when the composition of the deposit was actually analyzed, the proportion of the soluble organic fraction SOF component was found to be high.

When an EGR condition, determined by the EGR valve inlet temperature Tinegr and the concentration Xsof of the soluble organic fraction SOF, is in the deposit zone, the formation of a deposit in the EGR valve or the EGR cooler can be avoided by raising the EGR valve inlet temperature Tinegr.

Referring to FIG. 4, when the EGR condition is at a point A in the deposit zone, the EGR condition can be shifted to a point B in the non-deposit zone by raising the EGR valve inlet temperature Tinegr, even when the concentration Xsof of the soluble organic fraction SOF remains the same.

The EGR valve inlet temperature Tinegr can be raised by reducing the amount of coolant circulating through the EGR cooler to a lower value or to zero.

In the experiment results obtained by the inventors, the main component of the deposit was found to be the soluble organic fraction SOF, and this finding differs from the prior art, in which soot or HC is considered to occupy the main component proportion of the deposit.

Assuming that the research results obtained by the inventors are correct, when an air-fuel mixture having a rich air-fuel ratio is burned, deposit accumulation in the EGR valve or EGR cooler cannot be avoided even by closing the control valve such that the recirculated exhaust gas is not cooled.

Referring to FIG. 9, the SOF concentration Xsof obtained in the research performed by the inventors varies greatly according to differences in the rotation speed and load of the diesel engine, even when the air-fuel ratio of the air-fuel mixture remains the same. In a case shown in FIG. 4 where the air-fuel ratio is rich and the EGR condition is at a point C such that the formation of a deposit in the EGR valve or EGR cooler can be avoided, the SOF concentration Xsof of the exhaust gas increases when the running condition of the diesel engine shifts from a low load, low speed condition to a low-load, high-speed condition in FIG. 9. Similarly, the SOF concentration Xsof also increases when the running condition of the diesel engine shifts from a high load, high speed condition to a low load, high speed condition.

In other words, the SOF concentration Xsof may increase from the point C to a point D in FIG. 4, for example, due to variation in the running condition of the diesel engine, even when combustion is performed at an identical air-fuel ratio. In this case, if the coolant supply to the EGR cooler is controlled on the basis of the air-fuel ratio alone, it may be impossible to avoid deposit formation in the EGR valve or EGR cooler.

It is therefore an object of this invention to prevent the formation of a deposit in an EGR valve or an EGR cooler, regardless of variation in an EGR valve inlet temperature Tinegr and an SOF concentration Xsof.

In order to achieve the above object, this invention provides a control method for an exhaust gas recirculation device for a diesel engine. The diesel engine has an intake passage; an exhaust passage, and the exhaust gas recirculation device comprises an exhaust gas recirculation passage which leads a part of an exhaust gas in the exhaust passage to the intake passage as a recirculated exhaust gas, an exhaust gas recirculation valve which adjusts a flow in the exhaust gas recirculation passage, an exhaust gas recirculation cooler which cools the recirculated exhaust gas through heat exchange between the recirculated exhaust gas in the exhaust gas recirculation passage and a coolant, a coolant passage which circulates the coolant to the exhaust gas recirculation cooler, and a flow control valve which adjusts a coolant flow in the coolant passage,

The control method comprises determining a running condition of the diesel engine, determining a temperature of the recirculated exhaust gas in a predetermined location of the exhaust gas recirculation passage, calculating a concentration of a soluble organic fraction of the recirculated exhaust gas on the basis of the running condition, determining whether or not a deposit of a component of the recirculated exhaust gas is formed in the predetermined location of the exhaust gas recirculation passage on the basis of the temperature of the recirculated exhaust gas in the predetermined location and the concentration of the soluble organic fraction, and controlling the flow control valve to reduce the coolant flow in the coolant passage when the deposit of the component of the recirculated exhaust gas is determined to be formed in the predetermined location of the exhaust gas recirculation passage.

This invention also provides an exhaust gas recirculation device for the diesel engine comprising an exhaust gas recirculation passage which leads a part of an exhaust gas in the exhaust passage to the intake passage as a recirculated exhaust gas, an exhaust gas recirculation valve which adjusts a flow in the exhaust gas recirculation passage, an exhaust gas recirculation cooler which cools the recirculated exhaust gas through heat exchange between the recirculated exhaust gas in the exhaust gas recirculation passage and a coolant, a coolant passage which circulates the coolant to the exhaust gas recirculation cooler, a flow control valve which adjusts a coolant flow in the coolant passage, and a programmable controller.

The controller is programmed to determine a running condition of the diesel engine, determine a temperature of the recirculated exhaust gas, calculate a concentration of a soluble organic fraction of the recirculated exhaust gas on the basis of the running condition; determine whether or not a deposit of a component of the recirculated exhaust gas is formed in a predetermined location of the exhaust gas recirculation passage on the basis of the temperature of the recirculated exhaust gas and the concentration of the soluble organic fraction, and control the flow control valve to reduce the coolant flow in the coolant passage when the deposit of the component of the recirculated exhaust gas is determined to be formed in the predetermined location of the exhaust gas recirculation passage.

The details as well as other features and advantages of this invention are set forth in the remainder of the specification and are shown in the accompanying drawings.

### BRIEF DESCRIPTION OF THE DRAWINGS

FIG. 1 is a schematic diagram of a diesel engine comprising an EGR device according to this invention.

FIG. 2 is a schematic diagram of an EGR cooler.

FIG. 3 is a diagram illustrating a relationship between an EGR valve inlet temperature Tinegr and an SOF concentration Xsof, according to research performed by the inventors.

FIG. 4 is a diagram illustrating a deposit zone and a non-deposit zone determined on the basis of the EGR valve inlet temperature Tinegr and the SOF concentration Xsof, according to research performed by the inventors.

FIG. 5 is a flowchart illustrating a flow control valve control routine executed by a controller according to this invention.

FIG. 6 is a diagram showing the characteristic of a map of a recirculated exhaust gas temperature Tegr, which is stored by the controller.

FIG. 7 is a diagram showing the characteristic of a map of the EGR valve inlet temperature Tinegr, which is stored by the controller.

FIG. 8 is a diagram showing the characteristic of a map of a target EGR rate, which is stored by the controller.

FIG. 9 is a characteristic diagram of the SOF concentration Xsof, which is stored by the controller.

FIG. 10 is a diagram showing the characteristic of a map of a flow control valve opening correction amount, which is stored by the controller.

### DESCRIPTION OF THE PREFERRED EMBODIMENTS

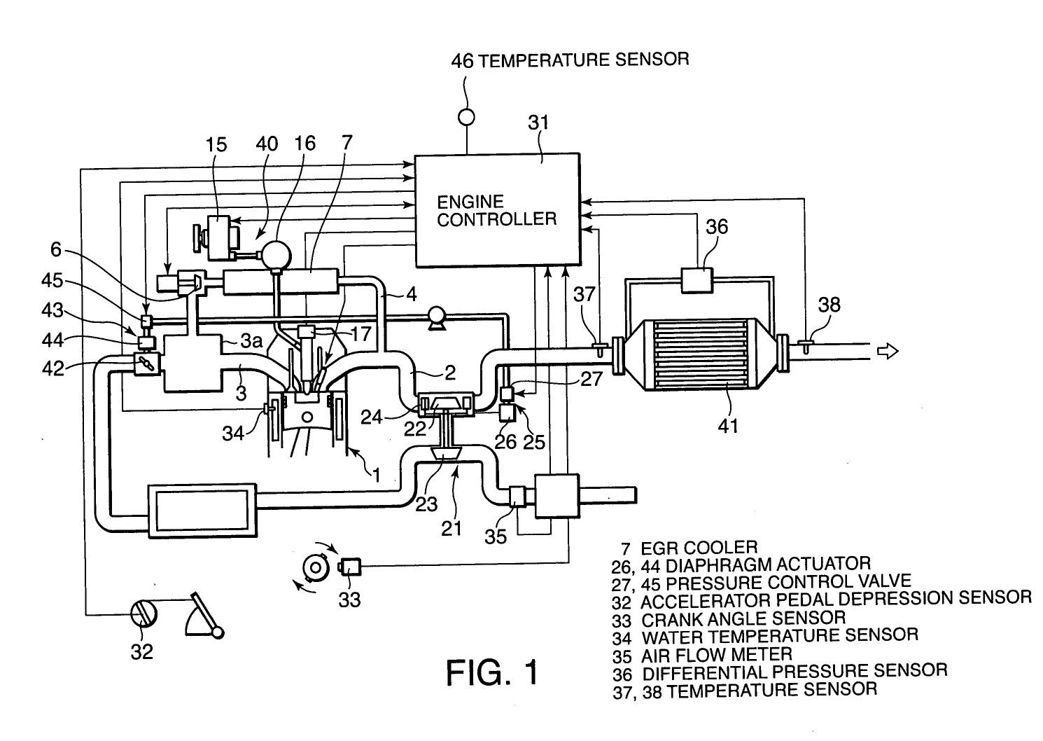

Referring to FIG. 1 of the drawings, a diesel engine 1 for a vehicle comprises a diaphragm EGR valve 6, which operates in accordance with a control pressure and is provided in an EGR passage 4 linking an exhaust passage 2 and a collector portion 3a of an intake passage 3.

The control pressure is generated by a pressure control valve, not shown in the figure, in accordance with a duty signal output by an engine controller 31. The engine controller 31 is constituted by a microcomputer comprising a central processing unit (CPU), read-only memory (ROM), random access memory (RAM), and an input/output interface (I/O interface). The engine controller 31 may be constituted by a plurality of microcomputers.

By having the engine controller 31 control the control pressure via the duty signal, an EGR rate corresponding to the running conditions of the diesel engine can be obtained. Another type of valve, for example a valve driven by a step motor, may be used as the EGR valve 6.

The diesel engine 1 comprises a common rail fuel injection device 40. The fuel injection device 40 comprises a fuel tank, a low-pressure pump, a high-pressure supply pump 15, a common rail 16, and an injector 17 provided for each of the cylinders of the diesel engine 1. The fuel tank and low-pressure pump are not shown in the figure.

Pressurized fuel from the high-pressure supply pump 15 is stored temporarily in the common rail 16. The pressure of the fuel in the common rail 16 is controlled to a desired state, and therefore the high-pressure supply pump 15 must pump only the required amount of fuel. For this purpose, the high-pressure supply pump 15 comprises a single linear solenoid type intake amount control valve which varies the surface area of an intake port of the high-pressure supply pump 15 to control the amount of fuel supplied to a plunger chamber of the high-pressure supply pump 15,

The high-pressure fuel in the common rail 16 is supplied to the injector 17 of each cylinder, and the injector 17 opens in accordance with an injection signal from the engine controller 31. As a result, the high-pressure fuel in the common rail 16 is injected directly into each cylinder.

The injector 17 is constituted by members such as a solenoid, a two-way valve, an outlet orifice, an inlet orifice, a command piston, and a nozzle needle. When the solenoid is not energized, the two-way valve keeps the outlet orifice in a closed state by means of a spring force. When an attempt is made to push the command piston downward in this state, the pressure in a control chamber at the upper end of the command piston becomes equal to the pressure attempting to push the nozzle needle upward, and as a result of a difference in pressure-receiving area and the elastic force of a nozzle spring, the nozzle needle abuts against a seat portion to maintain the closed valve state. Accordingly, fuel injection is not performed.

When the solenoid is energized, the two-way valve is pulled upward by a suction force of the solenoid, thereby opening the outlet orifice such that the fuel in the control chamber flows upward. As the fuel flows out, the control chamber pressure acting downward on the command piston decreases, causing the command piston and nozzle needle to rise, and hence fuel injection is performed through an injection hole. As the solenoid continues to be energized, the nozzle needle reaches a maximum lift, and a maximum injection rate is obtained.

When energization of the solenoid is cut off, the two-way valve falls, thereby closing the outlet orifice, and as a result, fuel flows into the control chamber through the inlet orifice such that the control chamber pressure rises. Accordingly, the nozzle needle falls rapidly and abuts against the seat portion. As a result, the injection hole closes and fuel injection ends.

Thus, the fuel injection timing is controlled in accordance with the timing at which the solenoid is energized, and the fuel injection amount is controlled in accordance with the duration of solenoid energization. By energizing and cutting off the solenoid repeatedly during a single stroke cycle of the piston, multi-stage injection can be realized.

The diesel engine 1 comprises a variable geometry turbocharger 21. The variable geometry turbocharger 21 comprises a turbine 22 provided in the exhaust passage 2 downstream of an opening portion of the EGR passage 4, which converts the thermal energy of the exhaust gas into rotational energy, and a compressor 23 connected to the turbine 22 on an identical rotational axis, which compresses the intake air in the intake passage 3 using rotational energy. A variable nozzle 24 driven by an actuator 25 is provided at a scroll inlet to the turbine 22. The opening of the variable nozzle 24 is controlled by an opening signal from the engine controller 31. In other words, the opening of the variable nozzle 24 is throttled to increase the flow speed of the exhaust gas flowing into the turbine 22 in a low rotation speed region of the diesel engine 1, and thus a predetermined supercharging pressure is obtained from the low rotation speed region. In a high rotation speed region, the variable nozzle 24 is opened fully so that the exhaust gas flows into the turbine 22 with no resistance.

The actuator 25 is constituted by a diaphragm actuator 26 which drives the variable nozzle 24 in accordance with a control pressure, and a pressure control valve 27 which adjusts the control pressure supplied to the diaphragm actuator 26. The engine controller 31 generates a duty control signal for aligning the actual opening of the variable nozzle 24 with a target nozzle opening, and outputs the duty control signal to the pressure control valve 27.

An intake throttle 42 driven by an actuator 43 is provided at the inlet to the collector portion 3a. The actuator 43 is constituted by a diaphragm actuator 44 which drives the intake throttle 42 in accordance with a control pressure, and a pressure control valve 45 which adjusts the control pressure supplied to the diaphragm actuator 44. The engine controller 31 generates a duty control signal for setting the intake throttle 42 at a target opening, and outputs the duty control signal to the pressure control valve 45.

Detection data from an accelerator pedal depression sensor 32 which detects a depression amount of an accelerator pedal provided in the vehicle, a crank angle sensor 33 which detects a crank angle and a rotation speed Ne of the diesel engine 1, a water temperature sensor 34 which detects a cooling water temperature in the diesel engine 1, and an air flow meter 35 which detects the flow rate of intake fresh air in the intake passage 3 are respectively input into the engine controller 31 as signals.

The engine controller 31 calculates the fuel injection timing and fuel injection amount on the basis of the engine load, which is represented by the accelerator pedal depression amount, and the engine rotation speed Ne, and outputs a corresponding injection command signal to the injector 17.

The engine controller 31 calculates a target common rail fuel pressure on the basis of the engine load and engine rotation speed Ne, and controls an intake air amount control valve of the high-pressure pump 15 such that the fuel pressure in the common rail 16 matches the target common rail fuel pressure.

Further, the engine controller 31 performs EGR control and supercharging pressure control in a coordinated manner to obtain a target EGR rate and a target supercharging pressure.

A diesel particulate filter 41 which traps particulate matter contained in the exhaust gas is disposed in the exhaust passage 2. When a particulate matter accumulation amount in the filter 41 reaches a predetermined threshold, regeneration processing of the filter 41 is begun so that the particulate matter that has accumulated in the filter 41 is removed through combustion.

To perform regeneration processing on the filter 41, a differential pressure sensor 36 for detecting pressure loss in the filter 41, or in other words a differential pressure ΔP upstream and downstream of the filter 41, is provided on a differential pressure detection passage which bypasses the filter 41, and temperature sensors 37, 38 for detecting an inlet temperature T1 of the filter 41 and an outlet temperature T2 of the filter 41, respectively, are also provided. Detection data from these sensors are respectively input into the engine controller 31 as signals.

On the basis of these data, the engine controller 31 determines a regeneration timing of the filter 41, and when it is determined that the regeneration timing has arrived, the engine controller 31 performs regeneration processing on the filter 41 by raising the temperature of the filter 41 to a target temperature using well-known exhaust gas temperature raising means. For example, the well-known exhaust gas temperature raising means may be constituted by control of the excess air ratio of the air-fuel mixture supplied to the diesel engine 1 to a value in the vicinity of a smoke limit.

To perform so-called complete regeneration of the filter 41 such that all of the particulate matter that has accumulated in the filter 41 is removed through combustion, the combustion temperature of the particulate matter must be raised as far as possible within a range that does not exceed an allowable temperature of the filter 41. For this purpose, the filter 41 is preferably coated with an oxidation catalyst. The oxidation catalyst promotes an oxidation reaction of the particulate matter, thereby substantially raising the bed temperature of the filter 41 and promoting combustion of the particulate matter in the filter 41.

In relation to the filter 41 carrying the oxidation catalyst, the engine controller 31 detects a bed temperature Tbed of the filter 41, and integrates periods during which the bed temperature Tbed reaches or exceeds a target bed temperature Tx to obtain an effective regeneration period te. On the basis of the effective regeneration period te, the engine controller 31 estimates a particulate matter regeneration amount PMr, which is an amount of the particulate matter trapped in the filter 41 that has been removed through combustion.

The engine controller 31 then calculates a particulate matter regeneration efficiency ηPM from the particulate matter regeneration amount PMr, and sets a target inlet temperature Td as high as possible on the basis of the regeneration efficiency ηPM.

The above regeneration operation of the filter 41 is known from U. S. Pat. No. 6,973,778.

The regeneration control method of the filter 41, performed by the engine controller 31, is not limited to the method described above, and any regeneration control method may be applied.

The diesel engine 1 comprises an EGR cooler 7 upstream of the EGR valve 6 in the EGR passage 4.

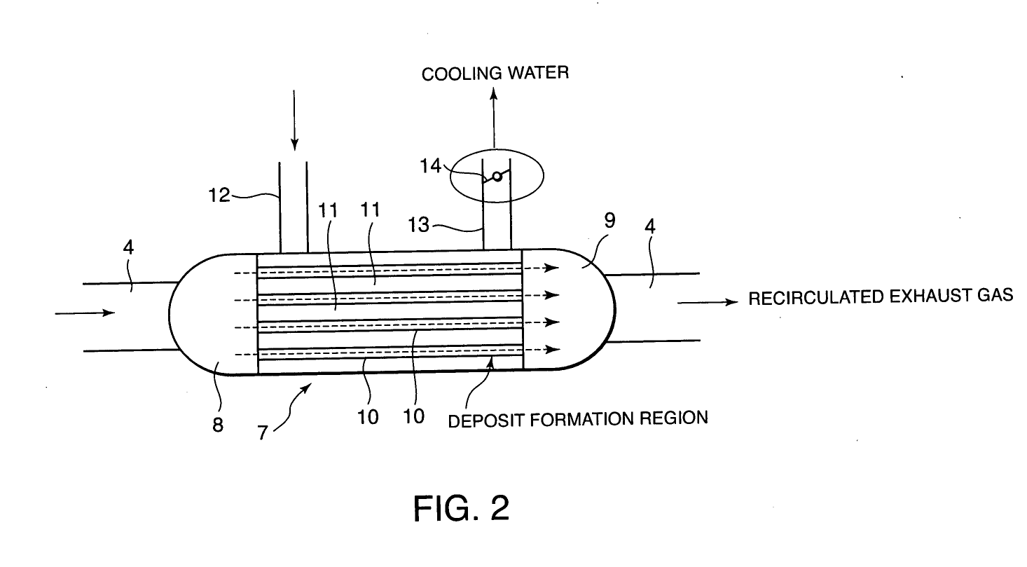

Referring to FIG. 2, the EGR cooler 7 is constituted by an inlet chamber 8 into which recirculated exhaust gas flows, an outlet chamber 9 in which the recirculated exhaust gas is collected, a plurality of straight pipes 10 connecting the inlet chamber 8 and outlet chamber 9, a cooling water chamber 11 filled with cooling water serving as a coolant, which is provided on the periphery of the straight pipes 10, a cooling water introduction pipe 12 which introduces cooling water into the cooling water chamber 11, and a cooling water discharge pipe 13 which discharges the cooling water in the cooling water chamber 11.

The EGR cooler 7 performs heat exchange between the high-temperature recirculated exhaust gas flowing through the straight pipes 10 and the cooling water in the chamber 11. After being cooled by this heat exchange process, the recirculated exhaust gas in the straight pipes 10 is collected in the outlet chamber 9 and led to the EGR valve 6 positioned directly downstream. The cooling water, the temperature of which has been raised by the heat exchange process, is discharged through the cooling water discharge pipe 13. Although not shown in the figure, the discharged cooling water is re-cooled in a radiator and re-supplied to the cooling water introduction pipe 12.

When the temperature of the recirculated exhaust gas is reduced by the EGR cooler 7 in the manner described above, the intake air charging efficiency of the diesel engine 1 improves, and therefore the amount of nitrogen oxide (NOx) in the exhaust gas of the diesel engine 1 can be reduced.

A flow control valve 14 which controls the flow of the cooling water in accordance with a duty control signal from the engine controller 31 is provided in the cooling water discharge pipe 13. As the opening of the flow control valve 14 increases, the flow of the cooling water circulating through the EGR cooler 7 rises and the temperature of the recirculated exhaust gas falls. The flow control valve 14 may be provided in the cooling water introduction pipe 12 instead of the cooling water discharge pipe 13.

The engine controller 31 estimates a recirculated exhaust gas temperature Tegr on the basis of the running conditions, determined by the load and the rotation speed Ne of the diesel engine 1. The engine controller 31 compares the recirculated exhaust gas temperature Tegr to a predetermined value T0. If the recirculated exhaust gas temperature Tegr is lower than the predetermined value T0, the engine controller 31 determines that there is no need to cool the recirculated exhaust gas using the EGR cooler 7, and therefore closes the flow control valve 14 fully.

When the recirculated exhaust gas temperature Tegr is equal to or higher than the predetermined value T0, the engine controller 31 determines that the recirculated exhaust gas needs to be cooled using the EGR cooler 7, and therefore opens the flow control valve 14 fully.

The recirculated exhaust gas is a part of the exhaust gas from the diesel engine 1, and therefore contains particulate matter. The particulate matter may be divided into a soluble organic fraction SOF that melts in an organic solvent, and an insoluble organic fraction ISF that does not melt in an organic solvent. The soluble organic fraction SOF component is constituted by hydrocarbon and lubricating oil, while the insoluble organic fraction ISF component is constituted by solid carbon and sulfur oxide.

When the recirculated exhaust gas containing these components is cooled by the EGR cooler 7, the components may accumulate as a deposit in a part of the straight pipes 10 near the outlet chamber 9, thereby blocking the straight pipes 10. Alternatively, the components may accumulate as a deposit in the interior of the EGR valve 6, thereby clogging the EGR valve 6.

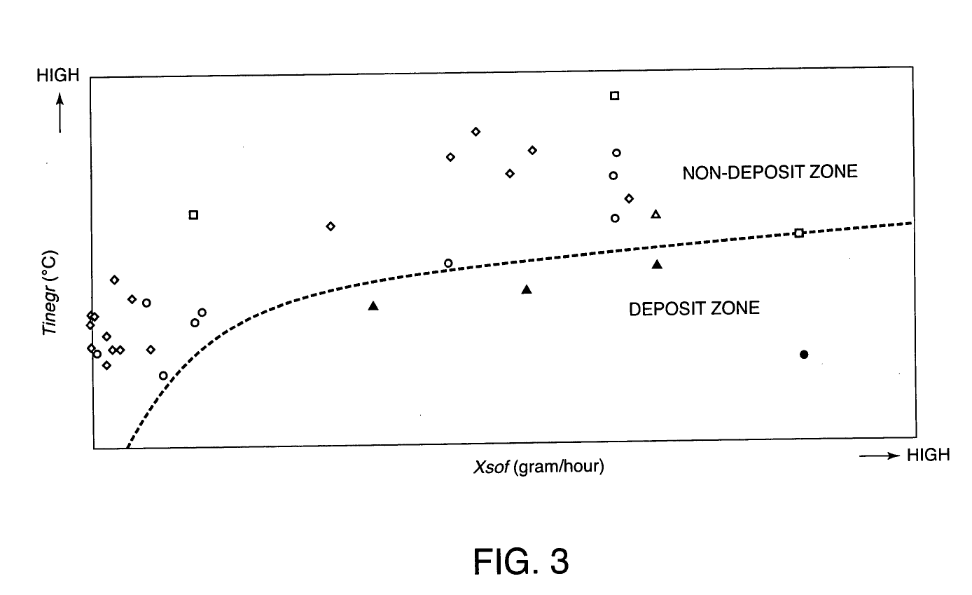

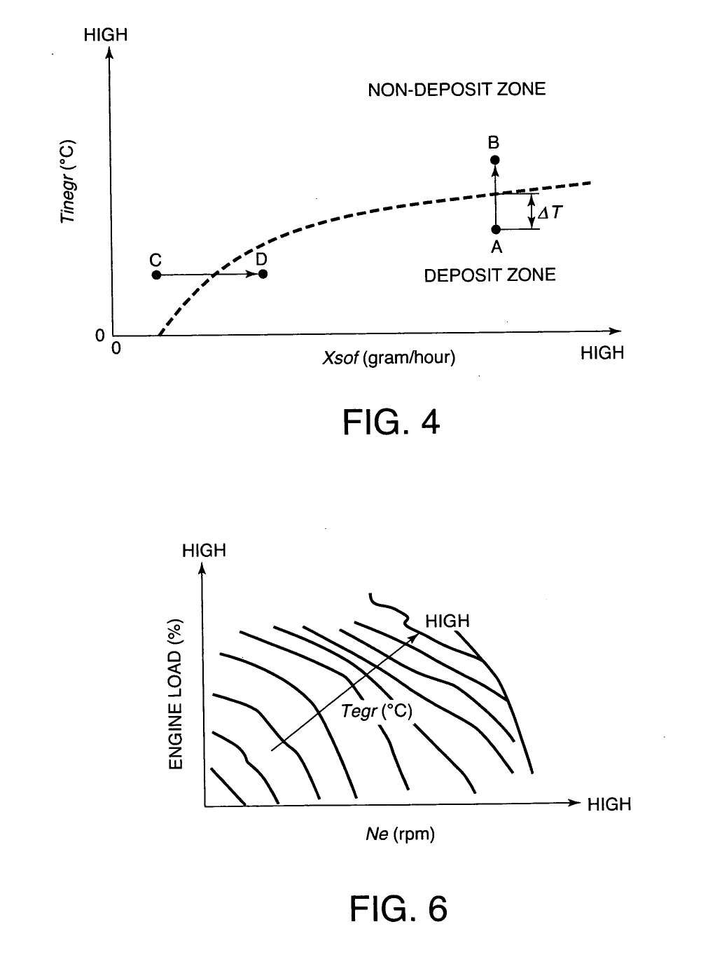

As described above, the inventors obtained the research results shown in FIGS. 3 and 4 with respect to deposit generation.

On the basis of these research results, the engine controller 31 estimates the EGR valve inlet temperature and the concentration of the soluble organic fraction SOF from the engine load and rotation speed Ne, and determines whether or not the EGR condition, which is defined by the EGR valve inlet temperature and the concentration of the soluble organic fraction SOF, is positioned in the deposit zone of FIG. 4.

When the EGR condition is positioned in the deposit zone of FIG. 4, the engine controller 31 reduces the cooling water flow to a lower value or to zero by reducing the opening of the flow control valve 14. As a result of this operation, deposit formation in the EGR valve 6 or EGR cooler 7 is prevented.

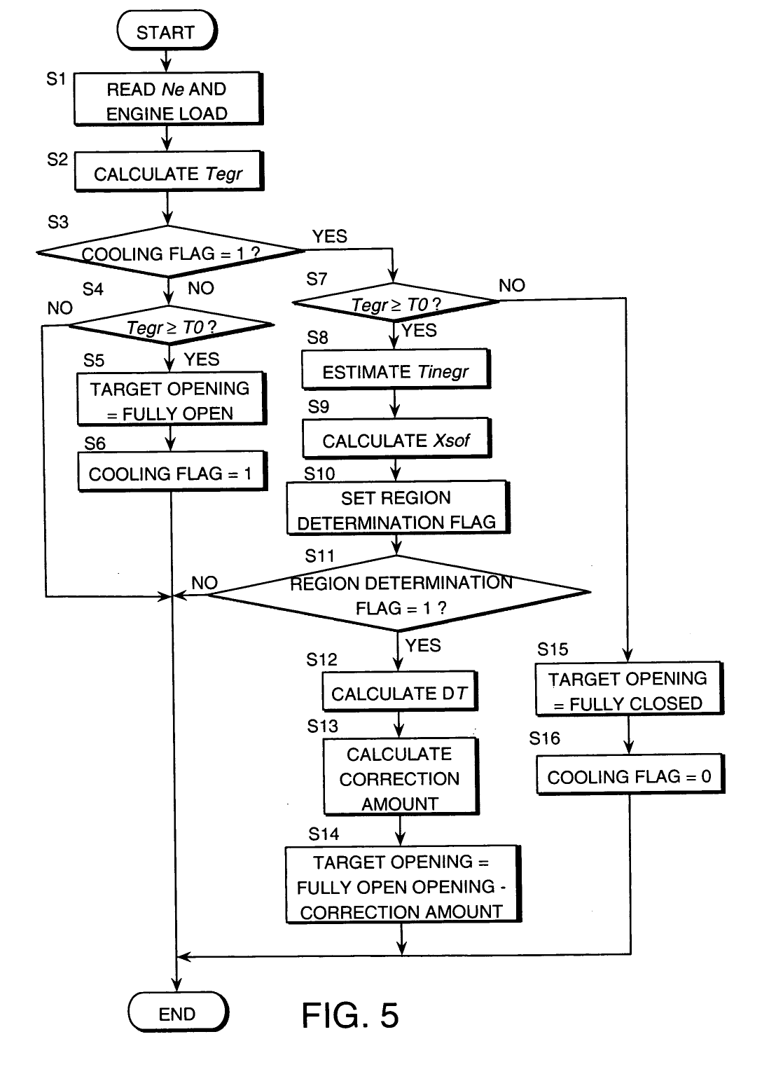

Referring to FIG. 5, a flow control valve control routine executed by the engine controller 31 to realize this control will be described. The engine controller 31 executes this routine at 10 millisecond intervals while the diesel engine 1 is operative.

In a step S1, the engine controller 31 reads the engine rotation speed Ne and the engine load, which is represented by the accelerator pedal depression amount.

In a step S2, the engine controller 31 calculates the recirculated exhaust gas temperature Tegr (° C.) from the rotation speed Ne and the engine load by referring to a map having the characteristic shown in FIG. 6, which is stored in the ROM in advance. This map essentially shows the exhaust gas temperature of the diesel engine 1 corresponding to the engine rotation speed Ne and the engine load, and in this embodiment, the exhaust gas temperature of the diesel engine 1 is used as the recirculated exhaust gas temperature Tegr.

As shown in FIG. 6, the recirculated exhaust gas temperature Tegr increases steadily as the load increases when the rotation speed Ne of the diesel engine 1 is constant. When the load of the diesel engine 1 is constant, the recirculated exhaust gas temperature Tegr increases steadily as the rotation speed Ne increases. The fuel injection amount may be used as the engine load instead of the accelerator pedal depression amount.

In a step S3, the engine controller 31 determines whether or not a cooling flag is at unity. The cooling flag will be described below. The initial value of the cooling flag is zero.

When the cooling flag is not at unity, the engine controller 31 compares the recirculated exhaust gas temperature Tegr to the predetermined value T0 (° C.) in a step S4. Here, the predetermined value T0 is a minimum value of the recirculated exhaust gas temperature at which cooling is required. If the recirculated exhaust gas temperature Tegr is lower than the predetermined value T0, the recirculated exhaust gas does not need to be cooled. In this case, the engine controller 31 terminates the routine immediately. In this case, a duty control signal corresponding to a fully closed position is output to the flow control valve 14.

When the recirculated exhaust gas temperature Tegr is equal to or higher than the predetermined value T0 in the step S4, the recirculated exhaust gas must be cooled. In this case, the engine controller 31 sets an opening corresponding to fully open as the target opening of the flow control valve 14 in a step S5. Following the processing of the step S5, the engine controller 31 sets the cooling flag to unity in a step S6, and then terminates the routine. In this case, a duty control signal corresponding to a fully open position is output to the flow control valve 14.

If the step S5 is executed, the determination of the step S3 in the next routine becomes affirmative.

In this case, the engine controller 31 compares the recirculated exhaust gas temperature Tegr and the predetermined value T0 (° C.) in a step S7.

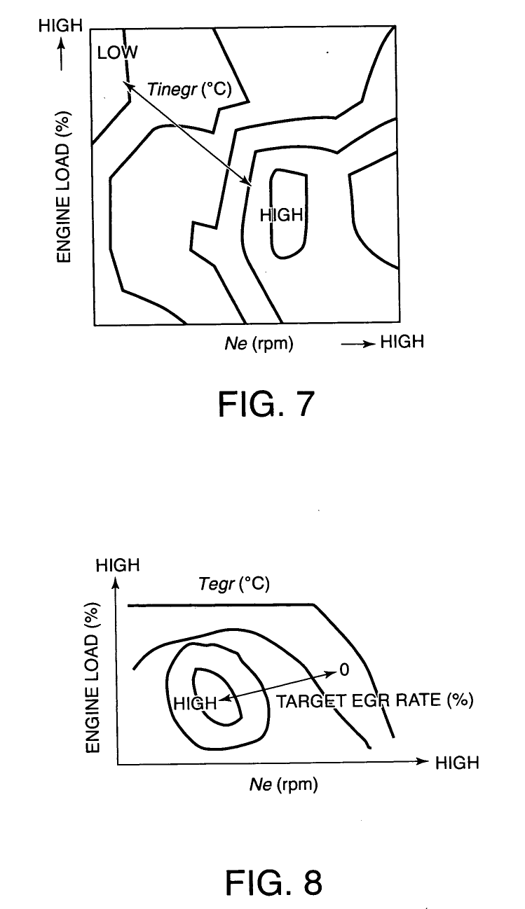

If the recirculated exhaust gas temperature Tegr is still equal to or higher than the predetermined value T0 in the step S7, the engine controller 31 estimates the EGR valve inlet temperature Tinegr (° C.) in a step S8 from the engine rotation speed Ne and engine load, by referring to a map having the characteristic shown in FIG. 7, which is stored in the ROM in advance. This map is preset through experiment in accordance with the engine rotation speed Ne and engine load.

As shown in FIG. 7, the EGR valve inlet temperature Tinegr is highest in a medium load, medium rotation speed region of the diesel engine 1, and decreases when the engine load either increases or decreases from this region. Similarly, the EGR valve inlet temperature Tinegr decreases when the engine rotation speed Ne either increases or decreases from this region. This characteristic is obtained as a result of determining the target EGR rate in the manner shown in FIG. 8.

More specifically, the target EGR rate is set to reach a maximum in the medium load, medium rotation speed region of the diesel engine 1, and set to decrease when either the engine load increases or decreases from this region, or the engine rotation speed increases or decreases from this region. By setting the target EGR rate in this manner, the EGR valve inlet temperature Tinegr reaches a maximum in the operating region of the diesel engine 1 where the target EGR rate reaches a maximum.

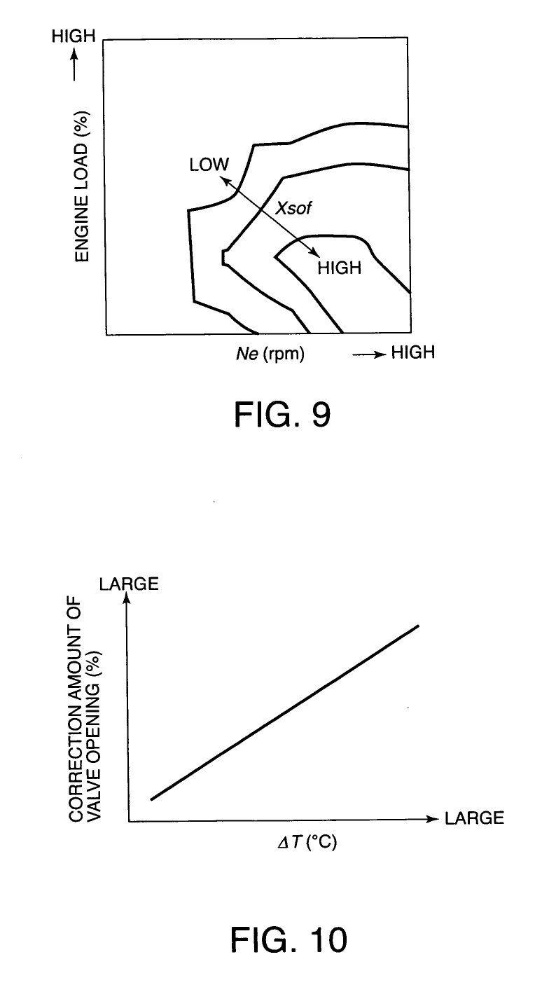

Next, in a step S9, the engine controller 31 determines the SOF concentration Xsof (gram/hour) from the engine rotation speed Ne and engine load by referring to a map having the characteristic shown in FIG. 9, which is stored in the ROM in advance. This map is also preset through experiment in accordance with the engine rotation speed Ne and engine load. According to FIG. 9, the SOF concentration Xsof is highest in a low load, high rotation speed region, and decreases when the load of the diesel engine 1 increases beyond this region or the rotation speed of the diesel engine 1 decreases below this region.

Next, in a step S10, the engine controller 31 determines, from the SOF concentration Xsof obtained in the step S9 and the EGR valve inlet temperature Tinegr obtained in the step S8, whether the EGR condition, which is defined by the SOF concentration Xsof and the EGR valve inlet temperature Tinegr, corresponds to the deposit zone or the non-deposit zone by referring to the map having the characteristic shown in FIG. 4, which is stored in the ROM in advance, and sets a region determination flag. It is assumed here that when the EGR condition corresponds to the deposit zone, the region determination flag is set to unity, and when the EGR condition corresponds to the non-deposit zone, the region determination flag is set to zero.

Next, in a step S11, the engine controller 31 determines whether or not the region determination flag is at unity. When the region determination flag is not at unity, the engine controller 31 immediately terminates the routine. In this case, the opening set during the previous execution of the routine is maintained, and a corresponding duty control signal is output to the flow control valve 14.

On the other hand, when the region determination flag is at unity, the engine controller 31 sets a target opening for the flow control valve 14 in steps S12-S14.

First, in the step S12, the engine controller 31 refers to the map having the characteristic shown in FIG. 4 to determine an EGR valve inlet temperature corresponding to the current SOF concentration Xsof as a reference temperature on the boundary line between the deposit zone and non-deposit zone, shown by the broken line in the figure, and calculates a differential temperature A T between the determined reference temperature and the current EGR valve inlet temperature Tinegr.

In the step S13, the engine controller 31 determines an opening correction amount for the flow control valve 14 from the differential temperature ΔT by referring to a map having the characteristic shown in FIG. 10, which is stored in the ROM in advance. This map is also set in advance through experiment.

In the step S14, the engine controller 31 calculates the target opening of the flow control valve 14 by subtracting the opening correction amount from the fully open opening, and then terminates the routine. In this case, a duty control signal corresponding to the target opening is output to the flow control valve 14.

The opening correction amount of the flow control valve 14 is a value for correcting the opening of the flow control valve 14 to a smaller opening. As shown in FIG. 10, the opening correction amount of the flow control valve 14 takes a larger value as the differential temperature ΔT increases. If the differential temperature ΔT is large when an EGR condition in the deposit zone is to be shifted to the non-deposit zone in FIG. 4, the recirculated exhaust gas temperature must be increased by a larger amount than the increase amount required when the differential temperature ΔT is small. Hence, as the differential temperature ΔT increases, the flow of the cooling water through the EGR cooler 7 must be reduced, and as a result, the opening correction amount increases.

Here, the EGR condition may be shifted from the deposit zone to the non-deposit zone by applying the opening correction amount only once, or the EGR condition may be shifted from the deposit zone to the non-deposit zone by dividing the opening correction amount into a plurality of parts and applying each part separately.

In the former case, the straight line on the map having the characteristic shown in FIG. 10 is preset at a large incline. As a result, the process of the steps S12-S14 is executed in a single execution of the routine, and in the step S11 of the next execution, the determination becomes negative.

In the latter case, the straight line on the map having the characteristic shown in FIG. 10 is preset at a small incline. As a result, the process of the steps S12-S14 is executed over a plurality of executions of the routine, and the determination of the step S11 only becomes negative thereafter.

A step for fully closing the flow control valve 14 immediately when the determination of the step S11 is affirmative may be provided in place of the steps S12-S14 for setting the target opening in accordance with the differential temperature ΔT.

When the recirculated exhaust gas temperature Tegr is lower than the predetermined value T0 in the step S7, the engine controller 31 determines that the recirculated exhaust gas does not need to be cooled by the EGR cooler 7, and sets an opening corresponding to fully closed as the target opening of the flow control valve 14 in a step S15. As a result, a duty control signal corresponding to the fully closed position is output to the flow control valve 14.

Next, in a step S16, the engine controller 31 resets the cooling flag to zero, whereupon the routine is terminated.

By executing the routine described above, deposit formation in the EGR valve 6 and EGR cooler 7 can be suppressed even when the EGR condition, including the EGR valve inlet temperature Tinegr and the SOF concentration Xsof, varies in accordance with variation in the running conditions of the diesel engine 1.

The contents of Tokugan 2005-358998, with a filing date of Dec. 13, 2005 in Japan, are hereby incorporated by reference.

Although the invention has been described above with reference to certain embodiments of the invention, the invention is not limited to the embodiments described above. Modifications and variations of the embodiments described above will occur to those skilled in the art, within the scope of the claims.

For example, in the embodiment described above, the EGR valve inlet temperature Tinegr is estimated from the engine rotation speed Ne and engine load, but a temperature sensor 46 may be provided in the EGR passage 4 between the EGR cooler 7 and EGR valve 6 such that the EGR valve inlet temperature Tinegr is detected directly.

In the routine shown in FIG. 5, the processing of the steps S4-S6 and S15-S16, which is based on the determinations of the steps S3 and S7 and the results thereof, is an optional step for implementing this invention in an optimal fashion. In the routine shown in FIG. 5, the minimum constitution for realizing this invention is the step S1 followed directly by the step S8.

The embodiments of this invention in which an exclusive property or privilege is claimed are defined as follows:

What is claimed is:

1. A control method for an exhaust gas recirculation device for a diesel engine, the engine having an intake passage an exhaust passage, and the device comprising an exhaust gas recirculation passage which leads a part of an exhaust gas in the exhaust passage to the intake passage as a recirculated exhaust gas, an exhaust gas recirculation valve which adjusts a flow in the exhaust gas recirculation passage, an exhaust gas recirculation cooler which cools the recirculated exhaust gas through heat exchange between the recirculated exhaust gas in the exhaust gas recirculation passage and a coolant, a coolant passage which circulates the coolant to the exhaust gas recirculation cooler, and a flow control valve which adjusts a coolant flow in the coolant passage, the method comprising:
determining a running condition of the diesel engine;
determining a temperature of the recirculated exhaust gas in a predetermined location of the exhaust gas recirculation passage;
calculating a concentration of a soluble organic fraction of the recirculated exhaust gas on the basis of the running condition;
determining whether or not a deposit of a component of the recirculated exhaust gas is formed in the predetermined location of the exhaust gas recirculation passage on the basis of the temperature of the recirculated exhaust gas in the predetermined location and the concentration of the soluble organic fraction; and
controlling the flow control valve to reduce the coolant flow in the coolant passage when the deposit of the component of the recirculated exhaust gas is determined to be formed in the predetermined location of the exhaust gas recirculation passage.

2. The exhaust gas recirculation method as defined in claim 1, wherein the predetermined location includes one or both of the exhaust gas recirculation cooler and the exhaust gas recirculation valve.

3. The exhaust gas recirculation method as defined in claim 1, wherein the method further comprises determining that the deposit of the component of the recirculated exhaust gas is more likely to be formed in the predetermined location of the exhaust gas recirculation passage as a temperature of the recirculated exhaust gas decreases in relation to a constant concentration of the soluble organic fraction.

4. The exhaust gas recirculation method as defined in claim 1, wherein the method further comprises determining that the deposit of the component of the recirculated exhaust gas is more likely to be formed in the predetermined location of the exhaust gas recirculation passage as the concentration of the soluble organic fraction increases in relation to a constant temperature of the recirculated exhaust gas.

5. The exhaust gas recirculation method as defined in claim 1, wherein the method further comprises setting an opening of the flow control valve to zero when the deposit of the component of the recirculated exhaust gas is determined to be formed in the predetermined location of the exhaust gas recirculation passage.

6. The exhaust gas recirculation method as defined in claim 1, wherein the method further comprises, when the deposit of the component of the recirculated exhaust gas is determined to be formed in the predetermined location of the exhaust gas recirculation passage, calculating a temperature of the recirculated exhaust gas at which the deposit of the component of the recirculated exhaust gas is not formed in the predetermined location of the exhaust gas recirculation passage as a reference temperature relative to a constant concentration of the soluble organic fraction, and setting the opening of the flow control valve on the basis of a difference between the reference temperature and the temperature of the recirculated exhaust gas.

7. The exhaust gas recirculation method as defined in claim 6, wherein the method further comprises setting the opening of the flow control valve to be steadily smaller as the difference between the reference temperature and the temperature of the recirculated exhaust gas in the predetermined location increases.

8. The exhaust gas recirculation method as defined in claim 1, wherein the method further comprises setting the opening of the flow control valve to zero when the temperature of the recirculated exhaust gas is lower than a predetermined temperature.

9. The exhaust gas recirculation method as defined in claim 1, wherein the method further comprises determining the temperature of the recirculated exhaust gas on the basis of the running condition of the diesel engine.

10. The exhaust gas recirculation method as defined in claim 1, wherein the running condition is a rotation speed and a load of the diesel engine.

11. An exhaust gas recirculation device for a diesel engine, the engine having an intake passage and an exhaust passage, comprising:
an exhaust gas recirculation passage which leads a part of an exhaust gas in the exhaust passage to the intake passage as a recirculated exhaust gas;
an exhaust gas recirculation valve which adjusts a flow in the exhaust gas recirculation passage;
an exhaust gas recirculation cooler which cools the recirculated exhaust gas through heat exchange between the recirculated exhaust gas in the exhaust gas recirculation passage and a coolant;
a coolant passage which circulates the coolant to the exhaust gas recirculation cooler;
a flow control valve which adjusts a coolant flow in the coolant passage; and
a programmable controller programmed to:
determine a running condition of the diesel engine;
determine a temperature of the recirculated exhaust gas;
calculate a concentration of a soluble organic fraction of the recirculated exhaust gas on the basis of the running condition;
determine whether or not a deposit of a component of the recirculated exhaust gas is formed in a predetermined location of the exhaust gas recirculation passage on the basis of the temperature of the recirculated exhaust gas and the concentration of the soluble organic fraction; and
control the flow control valve to reduce the coolant flow in the coolant passage when the deposit of the component of the recirculated exhaust gas is determined to be formed in the predetermined location of the exhaust gas recirculation passage.

12. The exhaust gas recirculation device as defined in claim 11, wherein the running condition is a rotation speed and a load of the diesel engine, and the exhaust gas recirculation device further comprises:
a sensor which detects the rotation speed of the diesel engine; and a sensor which detects the load of the diesel engine.

13. The exhaust gas recirculation device as defined in claim 11, wherein the predetermined location includes one or both of the exhaust gas recirculation cooler and the exhaust gas recirculation valve.

14. The exhaust gas recirculation device as defined in claim 11, further comprising a temperature sensor which is disposed in the exhaust gas recirculation passage between the exhaust gas recirculation cooler and the exhaust gas recirculation valve, wherein the controller is further programmed to determine a temperature in the predetermined location of the exhaust gas recirculation passage on the basis of a detected temperature of the temperature sensor.
